(19) United States
(12) Patent Application Publication
(10) Pub. No.: US 2023/0242046 A1
(43) Pub. Date: Aug. 3, 2023

(54) Improved Loudspeaker Assembly And System For Vehicles

(71) Applicant: Blueprint Acoustics Pty Ltd, Endeavour Hills, Victoria (AU)

(72) Inventor: Zeljko Velican, Endeavour Hills, Victoria (AU)

(73) Assignee: Blueprint Acoustics Pty Ltd, Endeavour Hills, Victoria (AU)

(21) Appl. No.: 17/766,907

(22) PCT Filed: Oct. 2, 2020
(86) PCT No.: PCT/AU2020/051055

§ 371 Date: Apr. 6, 2022

(30) Foreign Application Priority Data
Oct. 10, 2019 (AU) 2019903817
Feb. 21, 2020 (AU) 2020900505

(51) Int. Cl. B60R 11/02; H04R 1/02; H04R 1/28; H04R 5/02

(52) U.S. Cl. CPC B60R 11/0217; H04R 1/025; H04R 1/2849; H04R 5/02; H04R 2499/13

(57) ABSTRACT

A loudspeaker assembly for use in a vehicle, the vehicle including a cabin and one or more cabin walls, the assembly including a plurality of drivers fitted to a common enclosure, the enclosure including a vent duct passing through a cabin wall of a vehicle such that one side of the loudspeaker assembly is in acoustic communication with a volume of air external to the cabin of the vehicle and the other side of the loudspeaker assembly is in acoustic communication with air in the cabin of the vehicle.

### FIELD OF THE INVENTION

The invention relates to low frequency loudspeakers (woofers and subwoofers) for use in vehicles.

### BACKGROUND

Space for loudspeakers is extremely limited in vehicles, so woofers and subwoofers need to be able to adapt to small or irregular spaces. In addition, the loudspeaker assembly needs to be small compared to a typical woofer or subwoofer enclosure to minimize cost and weight. Attempts have been made to overcome this problem. One arrangement in the prior art was to use the trunk of a vehicle as an enclosure for the loudspeaker assembly. However, this arrangement has the disadvantage of leakage from the trunk into the cabin due to porous or flexible construction materials, and consequently poor sound quality. Another arrangement in the prior art was to use infinite baffle topology by venting to the external air, but this arrangement is limited to the number of locations where it is feasible to install due to the size and shape of the loudspeaker assembly.

It would therefore be desirable to provide an arrangement which ameliorates or at least alleviates one or more of the above problems or to provide an alternative.

It would further be desirable to provide greater flexibility in the location of the loudspeaker assembly and greater flexibility in the variation of vent duct dimensions, enclosure size and driver parameters without loss of sound quality.

A reference herein to a patent document or other matter which is given as prior art is not to be taken as an admission or a suggestion that the document or matter was known or that the information it contains was part of the common general knowledge as at the priority date of any of the claims.

### SUMMARY OF THE INVENTION

According to a first aspect, the present invention provides, a loudspeaker assembly for use in a vehicle, the vehicle including a cabin and one or more cabin walls, the assembly including a plurality of drivers fitted to a common enclosure, the enclosure including one or more vent ducts passing through the cabin wall of the vehicle such that one side of the loudspeaker assembly is in acoustic communication with a volume of air external to the cabin of the vehicle and the other side of the loudspeaker assembly is in acoustic communication with air in the cabin of the vehicle.

Preferably, the said volume of air is air which is external to the vehicle. The volume of air may be greater than 200 liters. For example, the volume of air may be between 200 liters and the volume of the atmosphere. A volume of at least 200 liters ensures optimal efficiency at the lowest frequencies contemplated for the loudspeaker system.

The enclosure may include a single compartment having access to the vent duct, and one or more drivers contained within the compartment. The enclosure may further include one or more compartments wherein each driver is contained in a separate compartment.

Preferably, the compartments have equal access to the vent duct. Further, the compartments may be of equal size and the drivers may be equidistant from one or more of the vent ducts. In an embodiment, the vent duct from the multiple compartments may be a common vent duct. In another embodiment, there may be a single vent duct, or multiple vent ducts passing through the cabin wall of the vehicle.

Advantageously, providing a common vent duct maximizes mixing of sound so that there is the option of applying distortion cancelling. It will be appreciated that the arrangement will still work with nearby vent ducts provided they are within a quarter wavelength of the highest frequency.

In one embodiment, in operation, the drivers are driven at different phases which remain constant across an operating band consistent with technology disclosed in Applicant's US20180255391 which is incorporated herein by reference. Applicant's US20180255391 regenerates an audio signal as multiple phase adjusted signals which when passed through individual amplifiers and drivers and acoustically recombined, cancel harmonics arising from the amplifiers and drivers. The present invention takes advantage of a common vent duct to enhance the cancellation as a result of improved acoustic mixing of signals.

### BRIEF DESCRIPTION OF DRAWINGS

The invention will now be described in further detail by reference to the accompanying drawings. It is to be understood that the particularity of the drawings does not supersede the generality of the preceding description of the invention.

FIG. 1 is a schematic diagram of a vehicle, in cross-section, illustrating the loudspeaker assembly installed in a vehicle according to the present invention;

FIG. 2 is a schematic diagram illustrating a front view of a basic loudspeaker assembly according to the present invention where drivers share a common compartment;

FIG. 3 is a schematic diagram illustrating a front view of a basic loudspeaker assembly according to the present invention where drivers have separate compartments;

FIG. 4 is a schematic diagram illustrating a side view of a basic loudspeaker assembly fitted to a single panel wall according to the present invention;

FIG. 5 is a schematic diagram illustrating a side view of a basic loudspeaker assembly fitted in a double panel wall according to the present invention;

FIG. 6 is a schematic diagram illustrating an interface between multiple compartments and a common vent duct in an embodiment;

FIG. 7 is a schematic diagram illustrating an interface between multiple compartments and a common vent duct in a further embodiment;

FIG. 8 is a schematic diagram illustrating an interface between multiple compartments and a common vent duct in a further embodiment;

FIG. 9 is a schematic diagram illustrating an interface between multiple compartments and a common vent duct in a further embodiment;

FIG. 10 is a schematic diagram illustrating an interface between multiple compartments and two vent ducts in a further embodiment and

FIG. 11 is a schematic diagram illustrating an embodiment of the present invention with three drivers in a three-dimensional shape.

### DETAILED DESCRIPTION OF THE INVENTION

### Definitions

A cabin refers to a passenger compartment or listening environment within a vehicle.

A common enclosure refers to as an enclosure with one or more speaker compartments.

A cabin wall includes walls constructed of a single panel as well as double panel walls constructed of inner and outer skins with a cavity between them and may include floor, roof, firewall, side walls or any perimeter boundary interfacing external environment.

An inner skin refers to a cabin side panel of a double panel wall and may include a steel panel, composite polymer panel, steel panel with fabric lining and the like.

An outer skin refers to a panel of a double panel wall interfacing air external to a vehicle and most commonly made of steel.

FIG. 1 is a schematic diagram of a vehicle A, in cross-section, illustrating the loudspeaker assembly B installed in the vehicle A according to the present invention. The loudspeaker assembly B radiates sound to interior air E in the vehicle cabin C and in operation vents (a backwave) via a vent duct G to exterior air F. The vent duct G may vary in length from the thickness of the panel on the vehicle it passes through and extend up to 30 centimeters beyond for example. In FIG. 1, the location of the loudspeaker assembly B is shown in the floor D for ease of illustration, but it will be appreciated that the loudspeaker assembly B may equally be installed in any cabin wall according to the definition provided above.

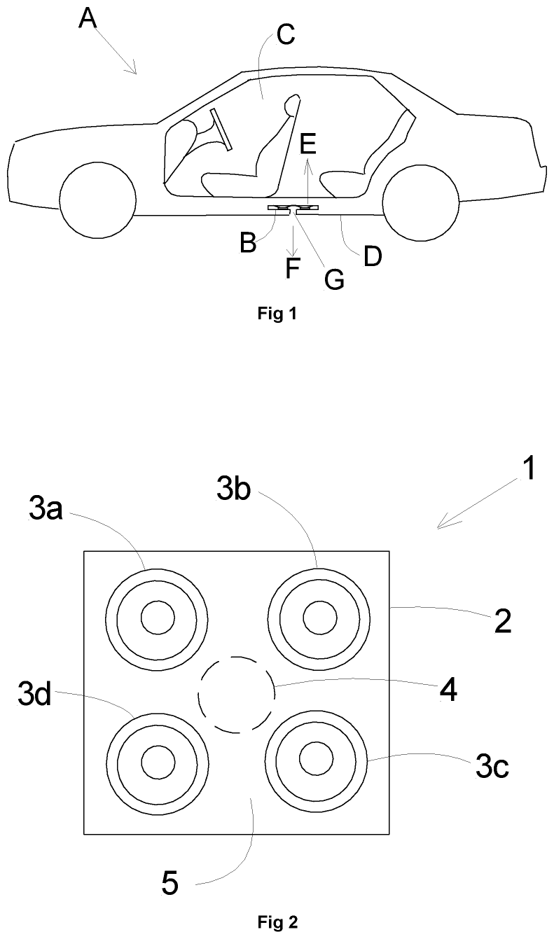

FIG. 2 is a schematic diagram illustrating a front view of a loudspeaker assembly 1. The loudspeaker assembly is provided in the cabin [not shown] of a vehicle. The loudspeaker assembly 1 includes an enclosure 2 fitted with four drivers 3a, 3b, 3c and 3d in a common compartment 5 having acoustic access to vent duct 4. Vent duct 4 passes through a boundary of a wall of the cabin [not shown] to air that is external to the vehicle. Although four drivers are shown, it will be appreciated that any number of drivers may be used to suit the circumstances of an installation.

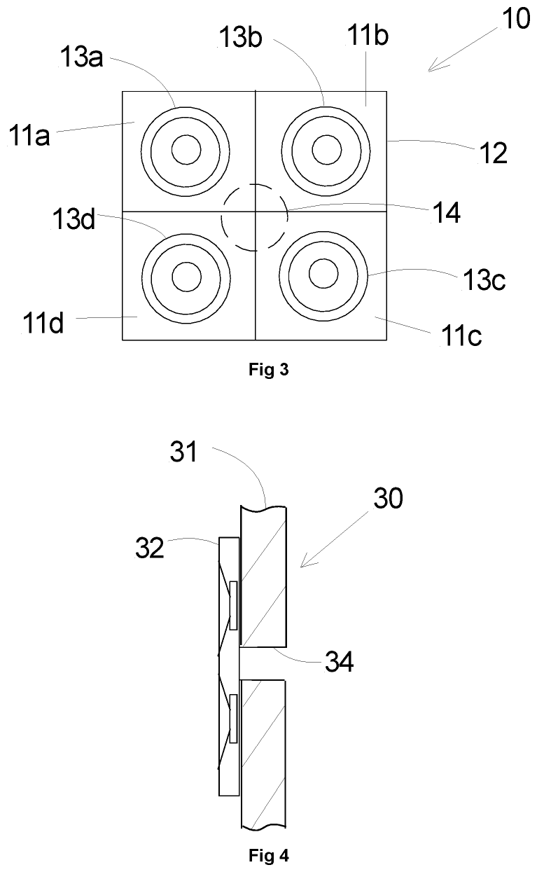

FIG. 3 is a schematic diagram illustrating a front view of a loudspeaker assembly 10. The loudspeaker assembly 10 includes an enclosure 11 having four compartments 12a, 12b, 12c and 12d. Each compartment is fitted with a driver 13a, 13b, 13c and 13d. A vent duct 14 passes through the boundary of the cabin wall from the cabin to air external to the vehicle as described with reference to FIG. 1. The vent duct includes a first end and a second end. The first end of the vent duct interfaces the enclosure 11 such that the air of each compartment 12a, 12b, 12c and 12d has equal acoustic access to the vent duct 14. In a preferred embodiment the compartments 12a, 12b, 12c and 12d are of equal volume and the drivers are equidistant from the vent duct. Any number of drivers may be provided each with their own compartments. For ease of understanding, FIGS. 2 and 3 illustrate a square cornered flat shaped enclosure 5, 11a to 11 d with square corners for illustrative purposes only. It will be appreciated that enclosure 11a to 11d may be shaped to match the contour of vehicle panels and otherwise shaped for styling purposes.

FIG. 4 is a schematic diagram illustrating a side view of a basic loudspeaker assembly 30 fitted to a cabin wall 31 inside a vehicle [not shown]. In this case, the cabin wall 31 is a single panel wall. A low-profile enclosure 32 vents to air exterior to a vehicle via vent duct 34. The corners of enclosure 32 are shown square for illustrative purposes only and may be styled to more attractive shapes.

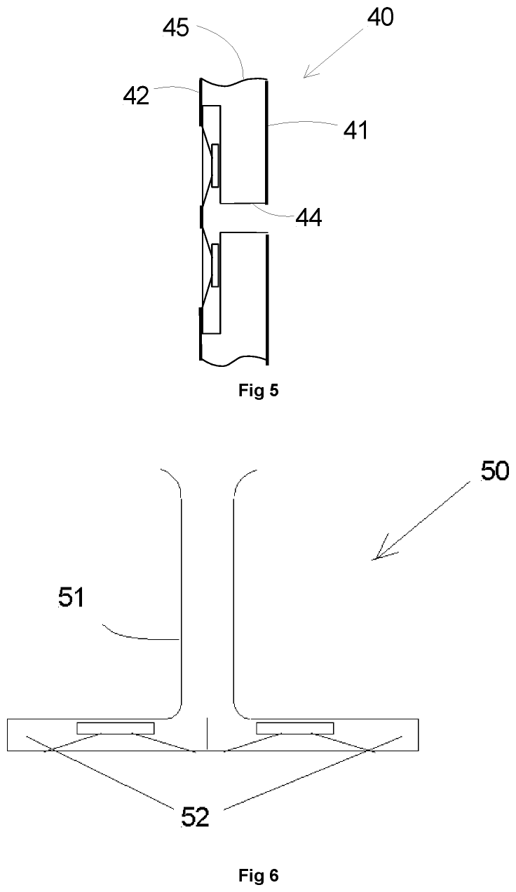

FIG. 5 is a schematic diagram illustrating a side view of a basic loudspeaker assembly 40 integrated into a cabin wall 45 of a vehicle. Cabin wall 45 has an inner skin 42 and an outer skin 41. In this case, the cabin wall 45 may be considered to be double panel wall. Enclosure 42 vents to air exterior to a vehicle via vent duct 44. It will be appreciated that an interior wall cavity may be used as a default enclosure provided that the cavity is well sealed and the inner and outer skins are rigid.

FIG. 6 is a schematic diagram illustrating the interface between multiple compartments and a common vent duct, according to an embodiment of the invention. In this embodiment, interfacing the vent duct 51 of the loudspeaker assembly 50 is provided by way of separate compartments 52. In this embodiment the vent duct 51 simply butts against the compartments 52 such that each compartment has equal access to the vent duct 51. The vent duct 51 may be flared at one or both ends as shown in FIG. 6 to prevent air noise.

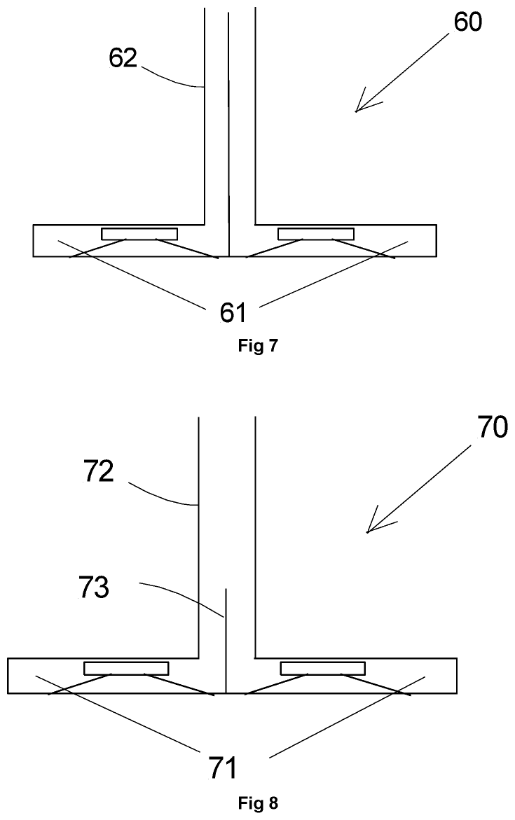

FIG. 7 is a schematic diagram illustrating the interface between multiple compartments and a common vent duct, according to a further embodiment of the invention. In this embodiment, the vent duct 62 of loudspeaker assembly 60 is interfaced with separate compartments 61. In this embodiment the vent duct 62 butts against the compartments 61 and is divided along its length to provide separate paths for venting each compartment.

FIG. 8 is a schematic diagram illustrating the interface between multiple compartments and a common vent duct, according to a further embodiment of the invention. In this embodiment, the vent duct 72 of the loudspeaker assembly 70 is interfaced with separate compartments 71. The arrangement shown in FIG. 7 is largely the same as in FIG. 6 except that the divider 73 extends part way along the length of the vent duct 72.

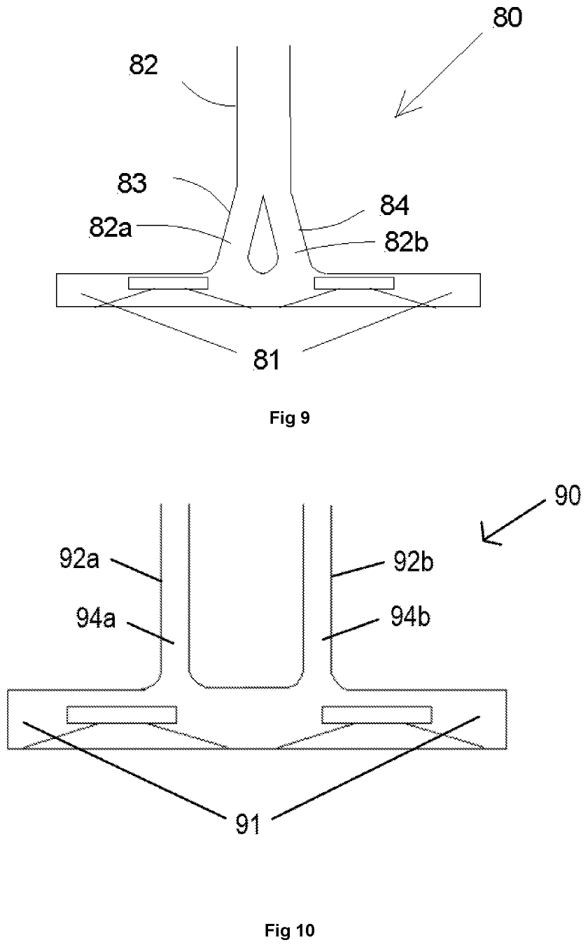

FIG. 9 is a schematic diagram illustrating the interface between multiple compartments and a common vent duct, according to a further embodiment of the invention. In this embodiment, the vent duct 82 of the loudspeaker assembly 80 is interfaced with separate compartments 81 whereby the vent duct 82 is forked such that the vent duct 82 is divided into two further vent ducts 83 and 84 forming separate channels 82a and 82b respectively leading from each compartment.

FIG. 10 is a schematic diagram illustrating the interface between multiple compartments and two vent ducts, according to a further embodiment of the invention. In this embodiment, the two vent ducts 92a, 92b of the loudspeaker assembly 90 is interfaced with separate compartments 91 whereby the vent ducts 92a, 92b separate channels 94a and 94b respectively leading from each compartment.

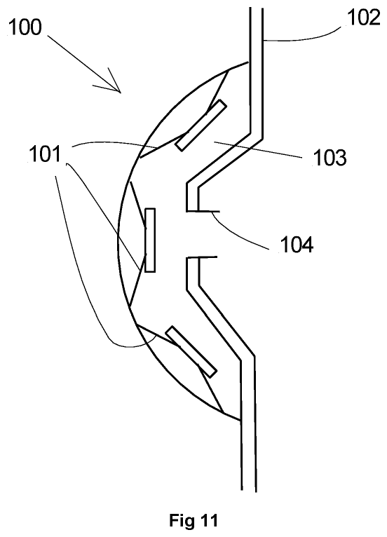

FIG. 11 is a schematic diagram illustrating an embodiment of the present invention with three drivers provided in a three-dimensional shape (although it will be appreciated that more than three drivers could be utilized depending on the application). Advantageously, the present invention provides for the ability to conform to existing vehicle panel shapes. This is impossible with large drivers because drivers require a flat surface to mount on. In FIG. 11, a loudspeaker assembly 100 is adapted to a bend in cabin wall 102 In FIG. 11, three small drivers 101 are used in place of a single larger one to allow the assembly to conform unobtrusively to the wall despite the shape of the wall 102. Clearly this principle can be extended or applied in numerous configurations.

Any number of small drivers may be used to replace a single larger driver. If the drivers are to be driven by a common amplifier and retain the same overall driver impedance as a single driver, four drivers may be connected in series parallel configuration. Regardless of how many drivers are used another option is to drive them with individual small amplifiers.

In a further enhancement the drivers may be driven at different phases which remain constant across the operating band consistent with technology disclosed in US20180255391. The present invention provides a means of improving the operation of the technology of US20180255391 by assisting the mixing of acoustic radiation from each driver.

While the invention has been described in conjunction with a limited number of embodiments, it will be appreciated by those skilled in the art that many alternative, modifications and variations in light of the foregoing description are possible. Accordingly, the present invention is intended to embrace all such alternative, modifications and variations as may fall within the spirit and scope of the invention as disclosed.

1. A loudspeaker assembly for use in a vehicle, the vehicle including a cabin and one or more cabin walls, the assembly including a plurality of drivers fitted to a common enclosure, the enclosure including one or more vent ducts passing through a cabin wall of a vehicle such that one side of the loudspeaker assembly is in acoustic communication with a volume of air external to the cabin of the vehicle and the other side of the loudspeaker assembly is in acoustic communication with air in the cabin of the vehicle.

2. A loudspeaker assembly according to claim 1 wherein the said volume of air is air which is external to the vehicle.

3. A loudspeaker assembly according to claim 1, wherein the volume of air is greater than 200 liters.

4. A loudspeaker assembly according to claim 1 wherein the common enclosure further includes a compartment having access to one or more of the vent ducts, and wherein the one or more drivers are contained within the compartment.

5. A loudspeaker assembly according to claim 1 wherein the common enclosure further includes one or more compartments and wherein each driver is contained in a separate compartment.

6. A loudspeaker assembly according to claim 1 wherein and the compartments have equal access to one or more of the vent ducts.

7. A loudspeaker assembly according to claim 1 wherein the compartments are of equal size and the drivers are equidistant from one or more of the vent ducts.

8. A loudspeaker assembly according to claim 1 wherein, in operation, the drivers are driven at different phases which remain constant across an operating band.

9. A loudspeaker assembly according to claim 1 wherein the vent duct from multiple compartments is a common vent duct.
